(19) United States
(12) Patent Application Publication
(10) Pub. No.: US 2011/0253883 A1
(43) Pub. Date: Oct. 20, 2011

(54) LIGHT COLLECTOR

(76) Inventors: Chien-Feng LIN, Hsinchu City (TW); Cheng-Yu Huang, Taoyuan County (TW); Te-Kai Ku, Hsinchu county (TW); Chuan-Yi Lin, Hsinchu City (TW)

(21) Appl. No.: 12/760,119

(22) Filed: Apr. 14, 2010

(51) Int. Cl. H01J 3/14

(52) U.S. Cl. 250/216

(57) ABSTRACT

A light collector is capable of collecting a incident light, comprises a light condenser having an incident surface and an exit surface, a light reflecting unit having two end surfaces and a receiving unit, wherein the incident light enters through the incident surface of the light condenser and the light condenser alters an optical distance and an optical direction of the incident light so that the incident light is transmitted evenly to the exit surface of the light condenser. A reflecting layer is positioned inside the light reflecting unit, and the light condenser is positioned at one end surface of the light reflecting unit in order to receive the incident light from the exit surface. The receiving unit is used to receive the incident light exiting from the light reflecting unit so that a photoelectrical process is carried out and the incident light is converted into electrical energy.

### FIELD OF THE INVENTION

The present invention relates to a light collector, and more particularly to a structure of a light collector with high efficiency of light collection.

### BACKGROUND OF THE INVENTION

The conventional photoelectric conversions are made from a plurality of photoelectric lens and corresponding photoelectric converting units. The photoelectric lens is utilized to focus the light onto the photoelectric converting units so that the light energy can be converted into the electrical energy, wherein the photoelectric converting units are formed on the substrate during the fabrication process. When the incident light is focused onto the photoelectrical converting units, precision of reflecting is required as there are gaps between the photoelectric lens and corresponding photoelectric converting units. Therefore, there is an accurate light reflecting problem. Although the incident light can be focused onto the corresponding photoelectric converting units through the photoelectric lens, but the incident light will not be transmitted evenly or effectively onto the corresponding photoelectric converting units via the photoelectric lens due to other factors, such as impure materials inside the photoelectric lens, which can result the incident light to be dispersed, scattered, interfered or diffracted. The efficiency of the light transmission will be drastically reduced.

To resolve the above-mentioned problems, a plurality of gear-shaped or a Bragg grating photoelectric lens is introduced and positioned at the same side of the incident light exiting from the photoelectric lens so that the incident light can be focused effectively and evenly. However, the gear-shaped lens and the Bragg grating design still require the photoelectric converting units to be accurately focused to the gear-shaped or Bragg grating lens so that the incident light can be effectively focused. Therefore, the focus precision is slightly off, the transmission and conversion of the incident light are seriously affectedly.

### SUMMARY OF THE INVENTION

In view of the foregoing shortcomings of the conventional designs, the present invention provides a light collector, capable of collecting effectively and evenly the incident light to the receiving unit without the need of accurately reflecting the incident light so that the light energy can be converted into the electrical energy easily.

The light collector of the present invention comprises a light condenser having an incident surface and an exit surface, wherein the incident light enters through the incident surface of the light condenser and the light condenser alters an optical distance and an optical direction of the incident light so that the incident light is transmitted evenly to the exit surface of the light condenser. The light collector of the present invention further comprises a light reflecting unit having two end surfaces, and a receiving unit, wherein a reflecting layer is positioned inside the light reflecting unit, and the light condenser is positioned at one end surface of the light reflecting unit in order to receive the incident light from the exit surface. The incident light exiting from the exit surface of the light condenser is transmitted through the reflecting layer to another end surface of the light reflecting unit. The receiving unit is positioning at another end surface of the light reflecting unit to receive the incident light exiting from the light reflecting unit so that a photoelectrical process is carried out and the incident light is converted into an electrical energy.

Compare to the conventional technologies, the present invention provides an improved light collector that is capable of collecting effectively and evenly the incident light to the receiving unit without the need of accurately focusing the incident light. The light energy can be converted into the electrical energy easily.

These features and advantages of the present invention will become more fully apparent from the following description and appended claims, or may be learned by the practice of the invention as set forth thereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that theses drawings depict only typical embodiments of the invention and are not therefore to be considered to be limiting of its scope, the invention will be described and explained with additional specificity and detail through the use of the accompanying drawings, in which:

FIG. 1 shows a schematic view of a light collector in accordance with a preferred embodiment of the present invention; and

FIG. 2 illustrates a schematic view of a light collecting process of the light collector in accordance with the preferred embodiment of the present invention.

### DETAILED DESCRIPTION OF THE PREFERRED EMBODIMENTS

For the purpose of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

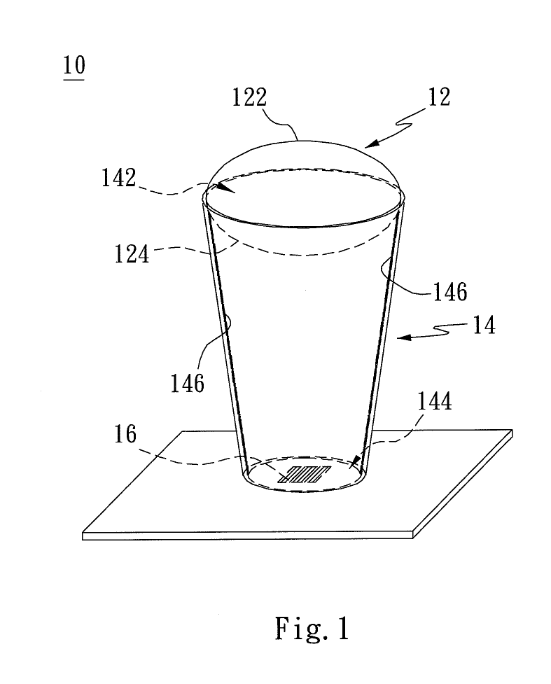

FIG. 1 shows a schematic view of a light collector in accordance with a preferred embodiment of the present invention. The light collector 10 comprises a light condenser 12, a light reflecting unit 14 and a light receiver 16. The light condenser 12 further comprises an incident surface 122 and an exit surface 124, wherein the light condenser 12 is made into a circular-shaped structure or an oval shaped ball. The light condenser 12 is made from materials that consist of high thermal coefficient or high coefficient of transparency so that the high transmission of light is achieved to allow the incident light source being transmitted easily in order to prevent the light energy of the incident light source from causing the material of the light condenser 12 to vary, and prevent the light efficiency to be affected by the variation.

The light condenser 12 is made from a colloid or a glass material. For example, when the light condenser 12 is made from the colloid, it can be the AB colloid. There are two end surfaces 142 and 144 on the light reflecting unit 14. A reflecting layer 146 is formed in the inner part of the light reflecting unit 14, and an end surface 142 of the light reflecting unit 14 is located in the light condenser 12 to receive the light source from the exit surface 124. The light received from the exit surface 124 is transmitted through the reflecting layer 146 and projected to another end surface 144 of the light reflecting unit 14. The reflecting layer 146 provides a total reflection of the incident light that is transmitted through the light reflecting unit 14. The reflecting layer 146 is coated or adhered to the inner part of the light reflecting unit 14. Preferably, the light reflecting unit 14 is designed in a cone-shaped unit. The receiving unit 16 is positioned at the other end surface 144 of the light reflecting unit 14 to receive the light transmitting from the light reflecting unit 14.

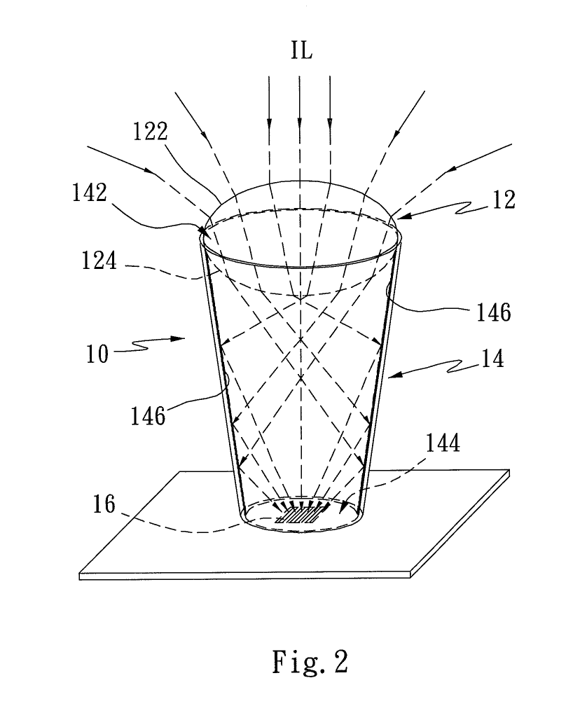

FIG. 2 illustrates a schematic view of a light collecting process of the light collector in accordance with the preferred embodiment of the present invention. The light collector 10 is utilized to collect the light from the incident light IL, wherein the incident light IL indicates that the focus of the light coming from all different directions. The light condenser 12 comprises an incident surface 122 and an exit surface 124, the incident light IL enters through the incident surface 122 into the light condenser 12 and the light condenser 12 changes the optical distance and optical direction so that the incident light IL can be transmitted evenly to the exit surface 124 of the light condenser 12. The light reflecting unit 14 comprises two end surfaces 142 and 144, wherein a reflecting layer 146 is positioned inside the light reflecting unit 14, and the light condenser 12 is located at the end surface 142 of the light reflecting unit 14 to collect the incident light IL existing from the exit surface 124 of the light condenser 12. The incident light IL transmitted out from the exit surface 124 is transmitted through the reflecting layer 146 to the other end surface 144 of the light reflecting unit 14.

From FIG. 2, it is clearly that the incident light is collected from all optical directions by the light reflecting unit 14 and through the light condenser 12, the optical distance and the optical direction of the incident light IL are altered. Preferably, the incident light IL is transmitted effectively by the light condenser 12 and/or the light reflecting unit 14 through a shortest optical distance. The design of positioning the receiving unit 16 at the other end surface 144 of the light reflecting unit 14 is to collect effectively the incident light IL existing from the light reflecting unit 14 so that the light energy can be converted into the electrical energy.

Compare to the conventional technologies, the present invention provides an improved light collector that is capable of collecting effectively and evenly the incident light to the receiving unit without the need of accurately reflecting the incident light. The light energy can be converted into the electrical energy easily.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features; which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A light collector, capable of collecting a incident light, comprising:
a light condenser, having an incident surface and an exit surface, wherein the incident light enters through the incident surface of the light condenser and the light condenser alters an optical distance and an optical direction of the incident light so that the incident light is transmitted evenly to the exit surface of the light condenser;
a light reflecting unit, having two end surfaces, a reflecting layer positioned inside the light reflecting unit, wherein the light condenser is positioned at one end surface of the light reflecting unit in order to receive the incident light from the exit surface, and the incident light exiting from the exit surface of the light condenser is transmitted through the reflecting layer to another end surface of the light reflecting unit; and
a receiving unit, positioning at another end surface of the light reflecting unit to receive the incident light exiting from the light reflecting unit so that a photoelectrical process is carried out and the incident light is converted into an electrical energy.

2. The light collector of claim 1, wherein the reflecting layer provides the incident light of the light reflecting unit a total reflection of photoelectrical process.

3. The light collector of claim 1, wherein the light condenser is made of colloid or a glass material.

4. The light collector of claim 2, wherein the light condenser is made into circular-shaped structure or an oval shaped ball.

5. The light collector of claim 1, wherein the light condenser is made from materials consisting of high thermal coefficient or high coefficient of transparency.

6. The light collector of claim 4, wherein the light condenser is made from materials consisting of high thermal coefficient or high coefficient of transparency.

7. The light collector of claim 3, wherein the light condenser is made of AB colloid.

8. The light collector of claim 1, wherein the light reflecting unit is made into a cone-shaped unit.

9. The light collector of claim 1, wherein the reflecting layer is coated or adhered onto an inner part of the light reflecting unit.

10. The light collector of claim 8, wherein the reflecting layer is coated or adhered onto an inner part of the light reflecting unit.
